(19) United States
(12) Patent Application Publication
(10) Pub. No.: US 2011/0203765 A1
(43) Pub. Date: Aug. 25, 2011

(54) Multipipe conduit for geothermal heating and cooling systems

(76) Inventor: Robert Jensen, Montvale, NJ (US)

(21) Appl. No.: 12/660,225

(22) Filed: Feb. 23, 2010

(51) Int. Cl. F24J 3/08; F16L 9/19

(52) U.S. Cl. 165/45; 138/111

(57) ABSTRACT

The present invention relates to a conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located pipe.

### BACKGROUND OF THE INVENTION

A. Field of the Invention

The present invention relates to a conduit comprising 5 or more pipes that are arranged around a central pipe. Said conduit is an integral part of a geothermal heating and cooling system. Geothermal heating and cooling systems are known for their superior performance in delivering efficient heating and cooling to homes, industrial buildings and residential and industrial complexes, as well as being environmentally clean and cost effective. See, for example,

http://www.igshpa.okstate.edu/geothermal/geothermal.html;
www.summitmechsystems.com/pages/3.1.html;
www.renewableheating101.com/geothermal/loops;
http://minnesotageothermalheatpumpassociation.com/geothermal/earth-loop-options/; and http://www.informedbuilding.com/Geothermal/Main16/Types-of-Geotherm. However, a barrier to the wide spread use of geothermal heating and cooling systems is the high cost of installation of the ground loop of pipes that the system requires. Also, the presently available ground-loop pipes are not ideal in terms of heat transfer and utilization of the borehole required to install the vertical ground loop pipes.

B. Description of the Related Art

The art has attempted to overcome these barriers to market entry for this efficient heating and cooling system. The aforementioned websites discuss the currently available ground loop technology. For example, the commonly used ground loop technologies are: horizontal ground loops, vertical ground loops, and slinky coil ground loops. However, horizontal ground loops require a substantial amount of land. Currently available vertical loops, including multiple pipe vertical loops, use less land, but their configuration does not optimize heat transfer, as does the present invention. Finally, the slinky coil ground loop is a variation of the horizontal ground loop and it too requires a substantial amount of land.

Also, inventors have sought patents on conduits to solve the problems with the current technology. For example, U.S. Pat. No. 5,630,447 ('447) discloses a pipe design that utilizes the entire borehole; and therefore transfers more heat to the ground. Further, the '447 invention allows for reduction in the size of the borehole required for a pipe capable of handling a specified flow of heat transfer fluid. The '447 invention, however, has some limitations. Said limitation being the pipe design and the cost of said design both in terms of time and money. The standards set by ASTM specify that pressure pipes have a round configuration. The pressure rating is derived by a combination of material strength and diameter to pipe wall thickness ration. The smaller this ration the higher the pressure rating of the pipe will be. The pipe represented in U.S. Pat. No. 5,630,447 is not round according to the standard, set by ASTM, to determine pressure tolerance of a pipe, and therefore cannot be governed by the same standard. Thus, new standards will need to be written and approved by standard setting bodies such as ASTM and IGSHPA. This process could be costly and time consuming. Additionally the U.S. '447 pipe inherently keeps the heat transferring fluid in the in and out flow pipes in close proximity to each other; thus causing heat contamination from the inflow to the outflow pipe. U.S. Pat. No. 5,630,447 does address this problem by introducing the notion of an insulating space between the inflow and outflow pipe. However, this design further complicates the pipe design certification issues.

Finally, U.S. Pat. No. 5,477, 914 ('914) discloses a ground source heat exchanger unit comprising a primary conduit and a plurality of secondary conduits for receiving heat transfer fluid. Said secondary conduits are spaced apart from each other. The '914 system is not designed for optimal use of the borehole due to the spacing between the secondary conduits. FIG. 1 of the '914 disclosure illustrates the fact that the '914 system requires greater land usage than a typical narrow borehole installation. Since the borehole is a very costly part of the installation of these systems, the '914 design becomes costly to install because of the larger diameter borehole required by the '914 system.

The '914 system will be inherently more cumbersome to manage because of the flexibility of the pipe in conjunction with the spacing required between the pipes. Specifically, it will be difficult to install the '914 invention in vertical boreholes and trenches because the pipes will tend to become disarranged from their designed arrangements. This is especially true when the installation takes place in a vertical borehole filled with water. The '914 inventor suggests a solution. He uses spacers installed at intervals on the pipe. However, this increases the cost of assembly and transportation of the '914 system.

Also, the '914 invention uses an insulated pipe. Said insulated pipe does not contribute to the heat transfer process while occupying space in the borehole, and system efficiency is compromised.

Vertical borehole installations of the ground loop are usually required to be at least partially grouted. To optimize heat transfer it is common to grout the entire bore. This is accomplished by the insertion of a grout pipe all the way to the bottom of the bore. This grout pipe can sometimes be very difficult to insert into the bore as it has a tendency to catch on various irregular surfaces. The added spacers in the '914 configuration in conjunction with the space between pipes will make inserting this grout pipe cumbersome and laborious because the pipe may get caught on the spacers.

Applicant's invention overcomes the problems with the art. Specifically, Applicant's arrangement, of 5 or more pipes around a centrally located pipe, makes efficient use of the bore hole space, while creating more heat transfer surface area than the presently available pipe configurations.

If desired, said centrally located pipe may optionally be a grout pipe. Said grout pipe eliminates the need for insulating material to prevent cross contamination between in and out flow pipes when the pipe is evacuated of grout and replaced with air.

In sum, the advantages of the Applicant's invention over the current technologies are:

1. The conduit of the present invention can be manufactured from existing components and use in the market can begin almost immediately.

2. The conduit of the present invention allows for greater thermal transfer from pipe to ground. For example, the multipipe configuration increases heat transfer surface area. Also, the pipe wall can be thinner because smaller diameter pipes may be used; thus increasing heat transfer. Air gaps between pipes promotes insulation and reduction in cross pipe thermal contamination. If desired, the optional grout pipe may be emptied of grout and replaced by air or any insulating gas, thus promoting pipe-to-pipe insulation.

3. The arrangement of the 5 or more pipes in the conduit of the present invention around a central pipe allows for efficient use of the borehole space.

4. The arrangement of the 5 or more pipes in the conduit of the present invention around a central pipe allows for flexibility in the design of the inflow and outflow pipe arrangement, thus optimizing heat transfer.

### SUMMARY OF THE INVENTION

The present invention relates to a conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located pipe.

### BRIEF DESCRIPTION OF THE DRAWINGS

FIG. 1 is a cross sectional view of an embodiment of the conduit of the present invention.

FIG. 2 is a cross sectional view of an embodiment of the conduit of the present invention.

FIG. 3 is a cross sectional view of an embodiment of the conduit of the present invention.

FIG. 4 is a side view of an embodiment of the conduit of the present invention.

FIG. 5 is a schematic of an embodiment of the conduit of the present invention.

FIG. 5a is a schematic of an embodiment of the conduit of the present invention as installed in a borehole.

### DEFINITIONS AND USAGES OF TERMS

The term “borehole”, as used herein, means a narrow shaft drilled in the ground for the purpose of installing a pipe. The borehole can be in a vertical direction, in a horizontal direction, in a diagonal direction or even deviated (i.e. turning). A borehole shaft is advantageous since it is narrow and requires less space and costly excavation and installation.

The term “ASTM standards”, as used herein, means the standards that must be complied with in order to produce pipe for geothermal heating and cooling systems. IGSHPA has installation guidelines that specify the piping systems that meet ASTM standards.

The term “grout pipe”, as used herein, means a pipe that is inserted into the borehole to facilitate the filling of the borehole with grout. The grout pipe is optional. Typically, the grout pipe is centrally located.

The term “support pipe”, as used herein, means a pipe that is not used to facilitate filling of the borehole with grout. In other words, said support pipe allows the designer of the conduit of the present invention to arrange the inflow and outflow pipes to optimize the efficiency of said conduit. Said support pipe is typically centrally located.

The term “contiguous”, as used herein, means touching, contacting, or abutting.

The term “inflow”, as used herein, refers to the movement of the fluid in the pipes in a vertical direction away from the structure to be heated or cooled and into the earth.

The term “outflow”, as used here, refers to the movement of the fluid in the pipes in a vertical direction toward the structure to be heated or cooled.

The number and arrangement of the inflow and outflow pipes is at the discretion of the assembler. There need not be an equal number of inflow and out flow pipes. Further, the location of the inflow and outflow pipes is at the discretion of the designer. In other words, any inflow or outflow pipe may be centrally located or said inflow and outflow pipes may be arranged around the central pipe.

As used herein, a “spacing member” is optionally used to separate in flow and out flow pipes. Additionally, said spacing member may optionally serve as an insulating material (i.e an insulator). Said insulating material is a foam or non foam material that is flexible enough to follow the contours of the conduit in any embodiment of the present invention.

### DETAILED DESCRIPTION OF THE INVENTION

The present invention relates to a conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located pipe.

The present invention further relates to a conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located grout pipe.

The present invention also relates to a conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located inflow or out flow pipe.

The present invention also relates to a conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located support pipe.

The Conduit of the Present Invention Comprises 5 or More Pipes Arranged Around a Central Pipe

Any number of pipes may comprise the conduit of the present invention. In other words, the number of pipes used to create the conduit of the present invention is at the discretion of the designer. The only requirement is that there be a centrally located pipe. Said centrally located pipe may optionally be a grout pipe or a support pipe.

In an embodiment of the invention, 5-20 pipes comprise the conduit of the present invention. One of the said 5-20 pipes must be a centrally located pipe. In another embodiment of the invention, 7-15 pipes comprise the conduit of the present invention. Again, one of the said 7-15 pipes must be a centrally located pipe. In yet another embodiment of the invention, 7-10 pipes comprise the conduit of the present invention, and one of said 7-10 pipes must be a centrally located pipe. In a further embodiment, 7 pipes comprise the conduit of the present invention, and 6 of said pipes are arranged around a central pipe. The pipes arranged around the central pipe may be either inflow or out flow pipes. Said inflow or outflow pipes may be arranged in contiguous fashion, arranged to be separated by a spacing member, or arranged so that said conduit comprised of said 5 or more pipes has both contiguous and separated pipes. Whether said pipe is inflow or outflow is at the discretion of the designer. Further, said central pipe may optionally be a grout pipe or a support pipe.

The arrangement of the 5 or more pipes around a central pipe is at the discretion of the designer. Using 5 or more pipes organized around a central pipe allows for flexibility in terms of inflow and outflow pipe arrangement for the purpose of optimizing heat transfer. For example, the 5 or more pipes of the conduit of the present invention can be arranged in 3 different ways: said 5 or more pipes of the conduit of the present invention can be arranged in contiguous fashion, arranged to be separated by a spacing member, or arranged so that said conduit comprised of said 5 or more pipes has both contiguous and separated pipes. The only requirement is that 1 pipe be a centrally located pipe.

One skilled in the art understands that the number of inflow and outflow pipes arranged around a central pipe is at the discretion of the designer and based on the needs of the user of the geothermal system. By way of non limiting example, in a 6 pipe embodiment, 3 pipes may be inflow pipes and 2 pipes may be outflow pipes and 1 pipe is the central pipe. In a 7 pipe embodiment, 4 pipes may be inflow pipes and 2 pipes may be outflow pipes and 1 pipe is the central pipe. In an 8 pipe embodiment, 2 pipes may be inflow pipes and 5 pipes may be outflow pipes and 1 pipe is the central pipe. In a 9 pipe embodiment, 4 pipes may be inflow pipes and 4 pipes may be outflow pipes and 1 pipe is the central pipe. In a 10 pipe embodiment, 5 pipes may be inflow pipes and 4 pipes may be outflow pipes and 1 pipe is the central pipe. Said central pipe may be a support or grout pipe.

In another embodiment of the invention, the inflow or outflow pipe may be centrally located. For example, in a 7 pipe embodiment, 1 pipe is a central outflow pipe, 4 pipes are inflow pipes and 2 pipes are outflow pipes arranged around the 1 central outflow pipe.

In a further embodiment of the invention, inflow and outflow pipes may be grouped together. For example, a possible arrangement may be a group of 3 inflow pipes and a group of 3 outflow pipes arranged around the central pipe. In another embodiment, inflow pipes may alternate with outflow pipes. In other words, the arrangement of pipes may be inflow pipe—outflow pipe—inflow pipe—outflow pipe; wherein said alternating in flow and out flow pipes are arranged around a central pipe. As stated hereinabove, the pipes may be arranged in a contiguous fashion, arranged to be separated by a spacing member, or arranged so that said conduit comprised of said 5 or more pipes has both contiguous and separated pipes.

Typically, the pipes useful in the present invention are plastic. Plastic materials suitable for piping include polyvinyl chloride (PVC), chlorinated polyvinyl chloride (CPVC), fibre reinforced plastic (FRP), reinforced polymer mortar (RPMP), polypropylene (PP), polyethylene (PE), cross-linked high-density polyethylene (PEX), polybutylene (PB), and acrylonitrile butadiene styrene (ABS), PEX/Aluminium/PEX for example. In an embodiment of the invention, PE and PEX are preferred.

The Optional Spacing Member

The optional spacing member is used to separate the in flow and out flow pipes. Additionally, said spacing member may optionally serve as an insulating material (i.e. an insulator). Said insulating material is a foam or non foam material that is flexible enough to follow the contours of the conduit

In an embodiment of the present invention, said optional spacing member may be a single unit piece. In a further embodiment of the invention, individual spacing members may be inserted between the pipes. The use and location of the spacing members is at the discretion of the designer.

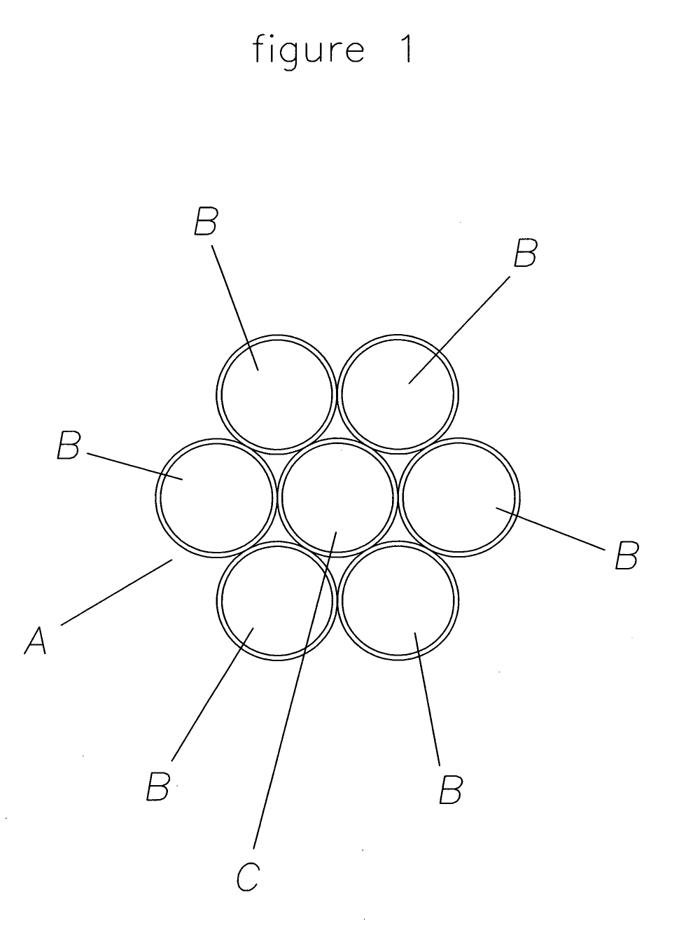

Non-limiting Embodiments of the Invention are illustrated in FIGS. 1-5a.

A conduit of the present invention comprised of 5 or more pipes arranged around a central pipe in a contiguous fashion is embodied in cross sectional FIG. 1. As illustrated in cross sectional FIG. 1, said inflow and out flow pipes (B) comprising said conduit (A) are arranged around a central pipe (C) in a contiguous fashion. Said central pipe (C) may optionally be a grout pipe or a support pipe.

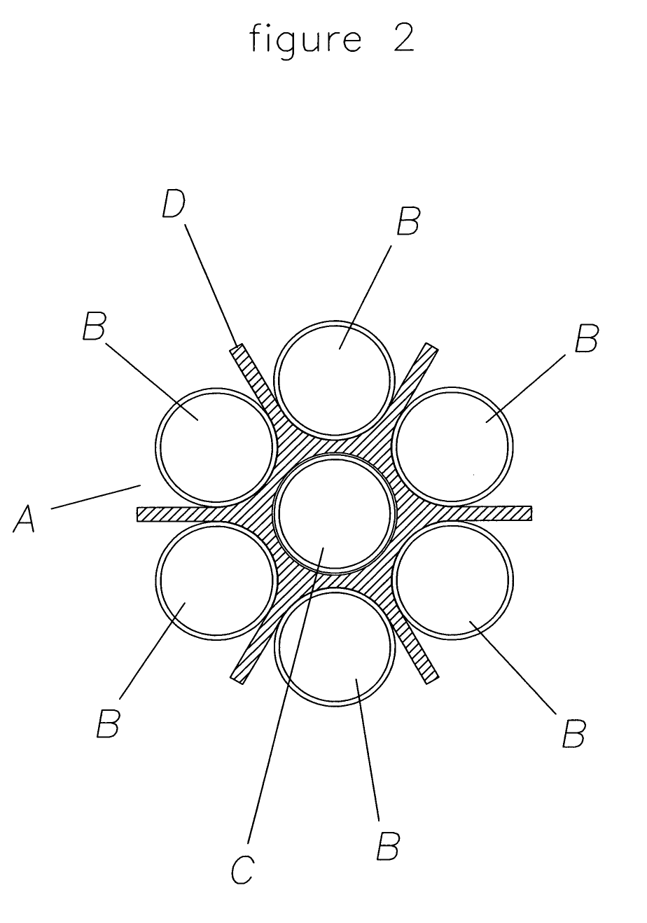

A conduit of the present invention comprised of 5 or more pipes, arranged around a central pipe, to be separated by a spacing member is embodied in cross sectional FIG. 2. As illustrated in FIG. 2, said inflow and out flow pipes (B) comprising said conduit (A) are arranged around a central pipe (C) and separated by a spacing member (D). In the FIG. 2 embodiment, said spacing member (D) is a single unit piece separating all the inflow and out flow pipes (B) and the central pipe (C) in the conduit (A). Said central pipe (C) may optionally be a grout pipe or a support pipe.

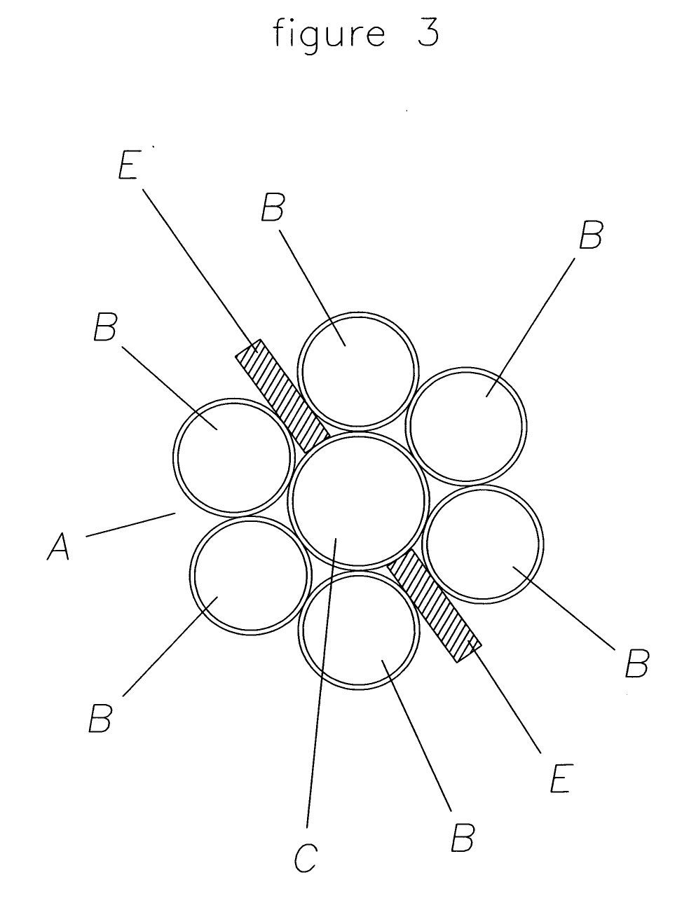

A conduit of the present invention comprised of 5 or more pipes, arranged around a central pipe, wherein some pipes are contiguous and some are separated by a spacing member is embodied in cross sectional FIG. 3. As illustrated in FIG. 3, said inflow and out flow pipes (B) comprising said conduit (A) are arranged around a central pipe (C) and separated by a spacing member (E). Said central pipe (C) may optionally be a grout pipe or a support pipe.

Further, when using the FIG. 3 contiguous and separated pipe arrangement, the contiguous and separated pipes can be in any number of patterns. Non limiting examples include, 3 pipes touching (i.e. contiguous) and 2 pipes separated by spacing members, 3 pipes separated by spacing members and 3 pipes touching; 3 pipes that are touching (i.e. contiguous) and connected by a spacer to three more pipes that are touching (i.e. contiguous) and are again connected to the former three pipes by a spacer. The only requirement is that there be a central pipe. Said central pipe is optionally a grout pipe or a support pipe.

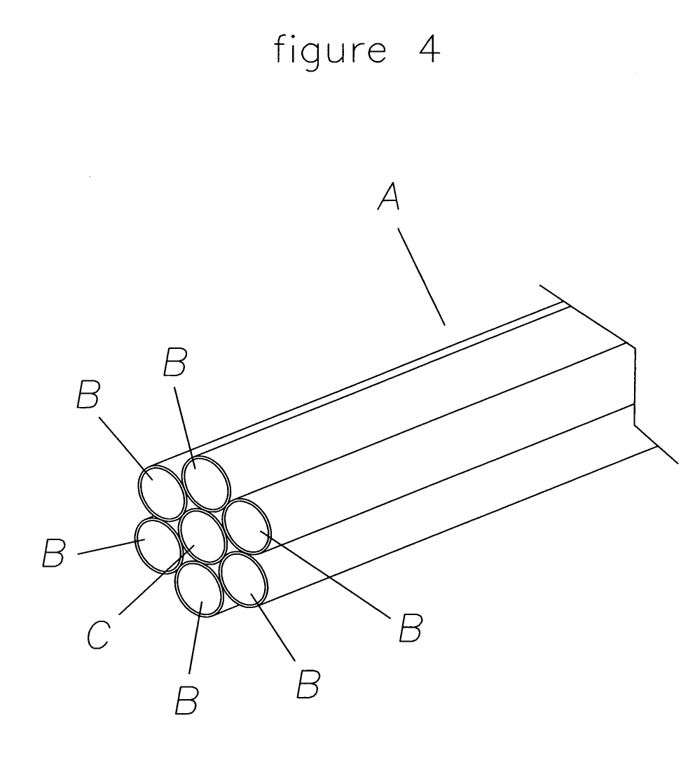

FIG. 4 is side view schematic of the conduit (A) of the present invention. Inflow and out flow pipes (B) are contiguous and arranged around a central pipe (C). Said central pipe (C) may optionally be a grout pipe or a support pipe.

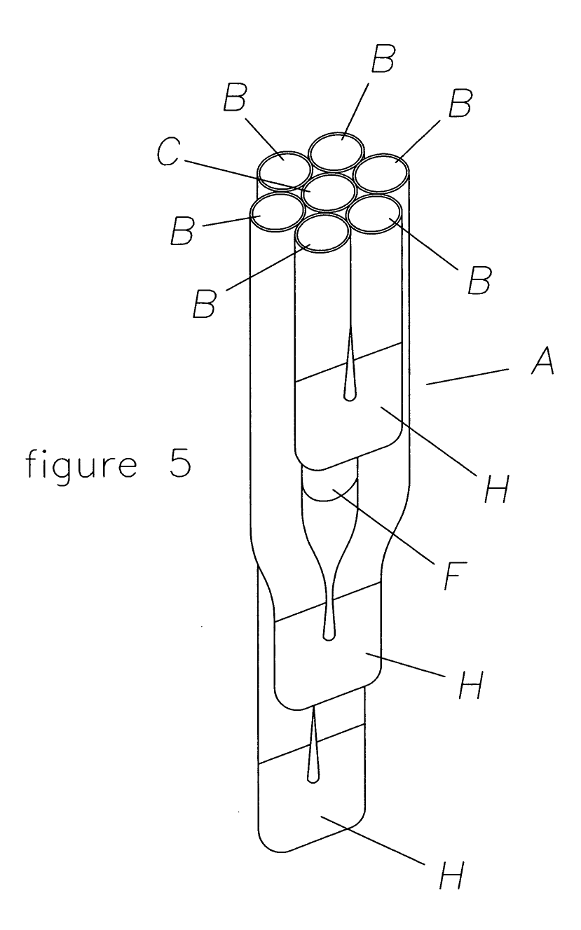

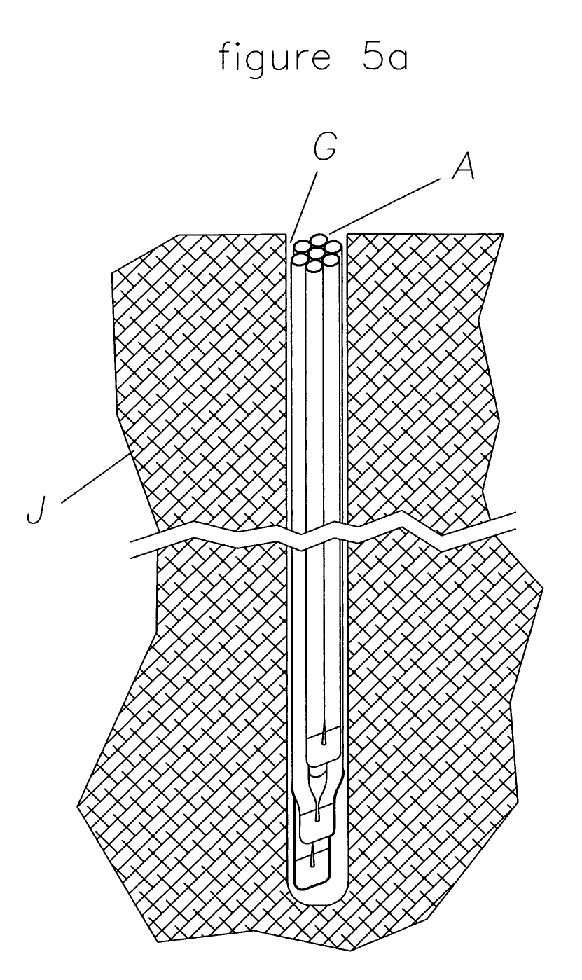

FIG. 5 is a schematic of the conduit (A) of the present invention. For example, said 5 or more inflow and out flow pipes (B) are arranged around a central pipe (C). Said 5 or more inflow and outflow pipes (B) are contiguous. Said 5 or more inflow and out flow pipes (B) are connected to U bend fittings (H). Said U bend fittings (H) allow the fluid in said 5 or more inflow and out flow pipes (B) to flow in and out of the conduit (A) of the present invention. The central pipe (C) terminates at open ended point (F). Said central pipe (C) may optionally be a grout pipe or a support pipe.

FIG. 5a is an embodiment of the conduit (A) of the present invention as it may be installed in a borehole (G). (J) represents the underground area where said borehole is drilled.

One skilled in the art understands that the pipe wall thickness will depend on the depth to which the pipe will go. For example, one ordinarily skilled knows that the greater the depth the greater the pressure the pipe will need to withstand.

One skilled in the art also knows that the size and length of the pipe can be varied according to the requirements of the system and the climate where the installation takes place, along with ground conditions of where the installation is taking place. Further, the fluid flowing through the pipes can be water or water with antifreeze solution.

Installation of the Conduit of the Present Invention

In an embodiment of the invention, the pre-fabricated conduit comprising 5 or more pipes arranged around a central pipe will be transported to the construction site for insertion into the borehole. The conduit of the present invention may also be fabricated on site if desired. There are several methods of installation (vertical, horizontal, diagonal, deviated). In a further embodiment of the present invention the conduit of the present invention is installed vertically by means known to those skilled in the art.

I claim:

1. A conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located pipe.

2. A conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located grout pipe.

3. A conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located inflow or out flow pipe.

4. A conduit for use in a geothermal heating and cooling system wherein said conduit comprises 5 or more pipes, wherein further, said 5 or more pipes comprising said conduit are arranged to be contiguous, arranged to be separated by a spacing member, or arranged so that said 5 or more pipes comprising said conduit have both contiguous pipes and pipes separated by a spacing member; wherein further, at least one of said 5 or more pipes is a centrally located support pipe.
